(19) United States
(12) Patent Application Publication
(10) Pub. No.: US 2010/0114732 A1
(43) Pub. Date: May 6, 2010

(54) METHOD AND APPARATUS FOR CREATING AND MANAGING MEDIASCAPES

(76) Inventor: Richard HULL, Bristol (GB)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/429,713

(22) Filed: Apr. 24, 2009

(30) Foreign Application Priority Data
Oct. 24, 2006 (GB) GB0621058.7
Oct. 24, 2007 (US) PCT/US2007/022620
Oct. 24, 2007 (WO) 2008/051595

(51) Int. Cl. G06F 3/048; G06Q 30/00; G06Q 50/00; G06Q 99/00

(52) U.S. Cl. 705/26; 705/1.1; 715/764

(57) ABSTRACT

A mediascape comprises media items and related action-triggers each specifying a condition set of one or more conditions, and at least one media-item-specific action that is to be triggered upon satisfaction of the condition set. During authoring (31) at least one action-trigger is specified with a location-based condition that has a customizable parameter; thereafter, the mediascape is released to a third party (34) with an indication that it contains a customizable parameter. The customizable parameter is then customized (38) in accordance with input from the third party (34) and the customized mediascape (39) is deployed to users for use.

### FIELD OF THE INVENTION

The present invention relates to the creation and management of mediascapes.

### BACKGROUND OF THE INVENTION

Mediascapes are collections of digital media items linked to the physical world through action-triggers. Each action-trigger specifies a condition set of one or more conditions concerning the physical world, and at least one media-item-specific action that is to be triggered upon satisfaction of the condition set; a typical condition would be a location-based condition satisfied upon a user entering a specified geographic zone. The action-triggers may be specified in a script which can be downloaded, along with the related media items to a user-portable device such as a hand-held computer. The user device interprets external inputs in accordance with the script to carry out specified media actions on particular ones of the stored media items. For example, a simple script might specify an action-trigger that causes the user device is to play a particular audio file whenever the user enters a particular city square.

A mediascape implementation architecture is described in the paper “Mobile Bristol Application Framework” Richard Hull, 2002 and the authoring of mediascapes is described in the paper “Rapid Authoring of Mediascapes” Richard Hull, Ben Clayton, & Tom Melamed The Sixth International Conference on Ubiquitous Computing. 2004. Nottingham, England; both papers are available via the online site: http://www.mobilebristol.com/. A suitable authoring tool for mediascapes has been made available online by Hewlett-Packard at: http://www.hpl.hp.com/mediascapes/. Herein the creator of a mediascape script is referred to as an ‘authors’.

In the known methodologies for creating and managing mediascape, trigger locations (including zones) have been fully specified by the author prior to release. This means, in the above example, that the precise shape and location of the spatial region used to trigger audio playback must be completely defined by the author. This has required the author to anticipate all of the locations of possible interest to third parties such as advertisers

### SUMMARY OF THE INVENTION

According to one aspect of the present invention, there is provided a method of creating and managing a mediascape comprising:
authoring a mediascape for a target environment, the mediascape comprising media items and related action-triggers each specifying a condition set of one or more conditions, and at least one media-item-specific action that is to be triggered upon satisfaction of the condition set; the condition set of at least one action-trigger comprising a location-based condition authored with a customizable parameter;
releasing the mediascape to a third party with an indication of said customizable parameter;
customizing said customizable parameter in accordance with input from said third party; and
deploying the customized mediascape to users for use in said environment.

According to another aspect of the present invention, there is provided a computer readable medium storing a program for authoring at least action-triggers of a mediascape that comprises media items and related action-triggers each specifying a condition set of one or more conditions, and at least one media-item-specific action that is to be triggered upon satisfaction of the condition set; the program when executed on a computer providing functionality for facilitating the authoring of a location-based condition with a customizable parameter by presenting an author with an opportunity to select a parameter of the location-based condition as customizable, and storing an indication that the parameter is customizable upon selection of the parameter by the author as customizable, the program causing this indication to be stored as part of the authored mediascape.

### BRIEF DESCRIPTION OF THE DRAWINGS

Embodiments of the invention will now be described, by way of non-limiting example, with reference to the accompanying diagrammatic drawings of embodiments of the invention, in which:

FIG. 1 is a diagram of a user device for running a mediascape;

FIG. 2 is a diagram illustrating the specification of trigger zones during authoring of a mediascape script;

FIG. 3 is a diagram illustrating the setting of parameters of a trigger zone as customizable during authoring of a mediascape script;

FIG. 4 is a diagram illustrating a first example scenario of mediascape customization subsequent to release from design;

FIG. 5 is a diagram illustrating one way of indicating to a third party that a trigger zone is customizable; and

FIG. 6 is a diagram illustrating a second example scenario of mediascape customization subsequent to release from design.

### BEST MODE OF CARRYING OUT THE INVENTION

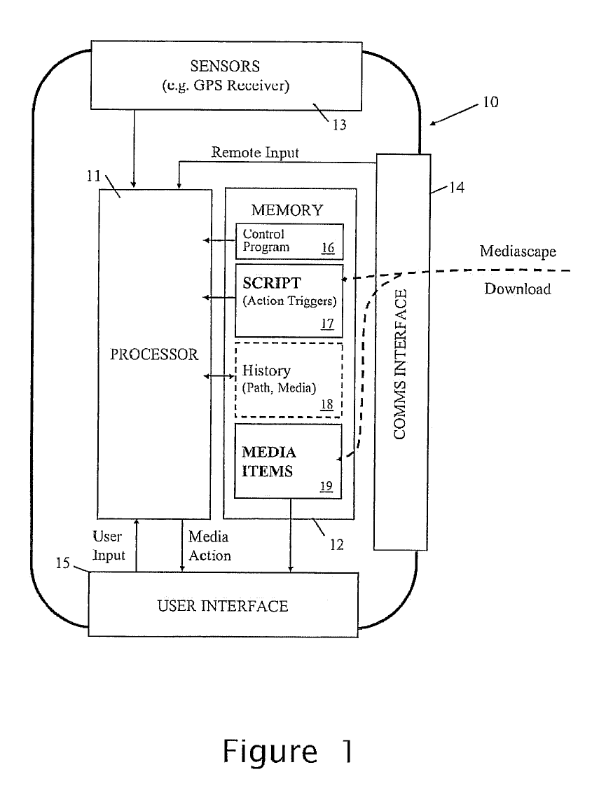

FIG. 1 illustrates an embodiment of a user-portable device 10 for running a mediascape. The device comprises a processor 11, a memory 12 (conventionally comprising volatile RAM for temporary, fast access, storage, and various forms of non-volatile memory such as ROM and disc-based storage), sensors 13 for sensing environmental parameters including location, a communications interface 14 (for example, a wireless LAN interface, and/or a USB connection), and a user interface 15 for providing audio and/or visual output and receiving user input (for example, via a keypad). With regard to the sensing of location, this is preferably done using a GPS receiver (part of sensors 13) though any other suitable arrangement can be used (for example, by detection of cellular radio signals, by reading location beacons, by an inertial navigation system, etc.).

The device 10 is arranged to download a mediascape via its communications interface 14 and store the mediascape components in its memory 12. In the present embodiment, the mediascape takes the form of a script 17 comprising a number of action-triggers, and a set of media items 19, such as audio and/or video files. A control program 16 may also be loaded with the mediascape or can be pre-installed on the device 10.

When run by processor 11 (for example in response to user selection) the control program 16 is arranged to control the device 10 in accordance with the mediascape script 17 and in dependence on inputs received by the processor 11 from the sensors 13, the communications interface 14 and the user interface 15. In a preferred embodiment, the control program 16 takes the form of an event manager arranged to handle input events, such as location updates and user input events, in accordance with corresponding event handlers specified in the mediascape script 17. For example, the event manager is arranged to handle a location update event from sensors 13 by running a location event handler that specifies one or more particular actions (play; pause; etc.) to be taken in respect of one or more specific media items when the device's current location, as provided by the location update event, satisfies a particular location condition specified in the location event handler. Thus, upon the user reaching a particular location, the location event handler may be arranged to cause a particular music file to be played to the user via the user interface 15. Other event handlers are provided for other types of events such as user input events and remote-input events.

As will be more fully described below, rather than the triggering of a media-item action being dependent on the satisfaction of a single condition (such as a location-based condition), the triggering of a media-item action can be made dependent on the satisfaction of a logical combination of conditions; for example, the playing of a media item can be made subject to satisfaction of both a location-based condition and a condition that the media item has not already been played (as indicated by an internal variable). More generally, the triggering of a media action can be made dependent on historical data concerning the path previously, taken by the user and the media items previously played (such historical data is indicated by dashed box 18 in FIG. 1).

Authoring of a mediascape script can be effected on a standard personal computer using, for example the above-referenced authoring tool available from Hewlett-Packard. A mediascape script can conveniently be written in a suitable XML language and an example script extract based on an XML language is given below for an event handler called LOCATION that is intended to handle location events with the device location as provided by a location update event from a location sensor, being contained in the variable “loc”.

```
<Event-Handler Name=“LOCATION” params= “loc”>
  <Action-Trigger Name=“AT1” condition=“loc= ‘Zone1’”>
    <Play type=‘audio’ url = ‘puzzle.mp3’/>
  </Action-Trigger>
  <Action-Trigger Name=“AT2” condition=“(loc=‘Zone2’) &&
  (parktuneplayed=false)”>
    <Play type=‘audio’ url= ‘parktune.mp3’/)
    <Set parktuneplayed=True/>
  </Action-Trigger>
</Event-Handler>
```

The above location event handler comprises two action-triggers, one (named “AT1”) in respect of a location zone ‘Zone1’ and the other (named “AT2”) in respect of a location zone ‘Zone2’. The zones ‘Zone1’ and ‘Zone2’ are separately specified with reference to the same real-world geographical coordinate system as is used for the location updates.

Each action-trigger specifies a condition set (“condition” in the above example) of one or more conditions, and at least one media-item-specific action that is to be triggered upon satisfaction of the condition set.

The condition set of the action-trigger “AT1” comprises a single condition:
loc=‘Zone1’
   which the control program 16 is arranged to interpret as being satisfied when the location contained in the variable ‘loc’ lies within the geographic zone ‘Zone1’. The action-trigger AT1 specifies a single action to be executed upon satisfaction of its condition set:
Play type=‘audio’ url=‘puzzle.mp3’
   which the control program 16 is arranged to interpret as a command to play, via audio output means of the device user interface 15, the audio file ‘puzzle.mp3’.

The condition set of the action-trigger “AT2” comprises two conditions:
(loc=‘Zone2’) && (parktuneplayed=false)
   both of which must be true for the condition set to be satisfied (it will be appreciated that any desired logical combination of conditions can be specified and not just an AND combination as in the present example). The control program 16 is arranged to interpret the first condition (loc=‘Zone2’) as being satisfied when the location contained in the variable lies within the geographic zone ‘Zone2’. The second condition (parktuneplayed=false) tests a variable ‘parktuneplayed’ which is initialized to ‘false’ but is set ‘true’ after the audio file ‘parktune.mp3 ’ has been played, this being done to avoid the file being played more than once. The action-trigger AT2 specifies two actions to be executed upon satisfaction of its condition set:

<Play type=‘audio’ url= ‘parktune.mp3’/)
<Set parktuneplayed=True/>

The control program 16 is arranged to interpret the first action as a command to play, via audio output means of the device user interface 15, the audio file ‘parktune.mp3’; the second action causes the program to set the variable ‘parktuneplayed’ to ‘true’.

When the device 10 is controlled with the above example script, the reporting of the current location of the device in a location update event results in the LOCATION event handler being run to determine if the condition set of any of the location-based action-triggers contained in the event handler has been satisfied and, if so, the specified action or actions is/are executed. Thus if the user device 10 is located in geographic Zone1 the audio file ‘puzzle.mp3’ is played, whereas if the user device 10 is in geographic Zone2 the audio file ‘parktune.mp3’ is played, but only if it has not already been played.

Of course, the foregoing script only requires a text editor program to author. The role of authoring tools is generally to provide additional support such as for specifying the location zones Zone1 and Zone 2 or to aid persons not comfortable with writing in an XML style language.

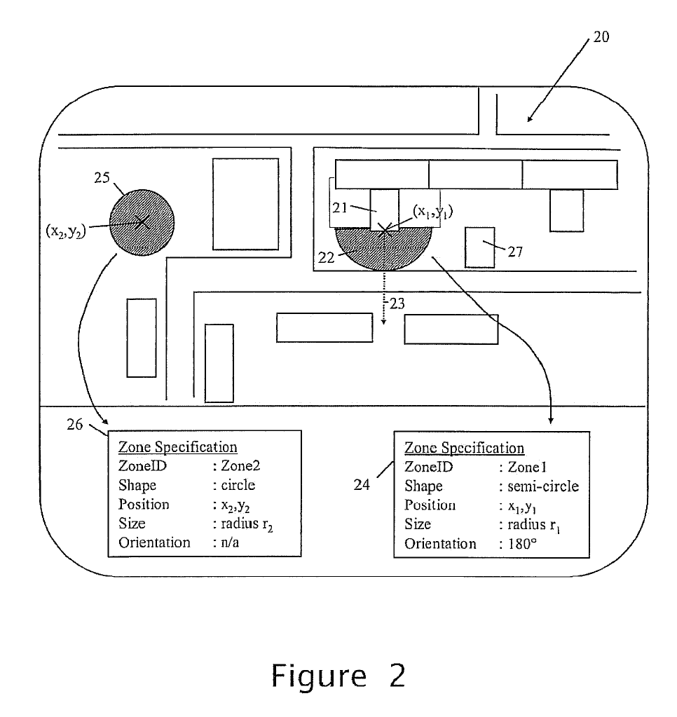

FIG. 2 illustrates a screen presented to a user by an example authoring tool in order to facilitate the specification of the geographic zones Zone1 and Zone2 of the above script example. The top two thirds of the screen displays a map representation 10 of the geographic area for which the mediascape is being authored. To specify a zone, an author may simply be required to click on the map representation 10 at the intended focal point of the zone (such as the centre of an intended circular zone, whether partial or full). In response, the authoring tool can be arranged to bring up a zone specification template in the lower third of the screen with the real-world geographic coordinates of the clicked map position already filled in. Thus to specify Zone1 as a semi-circular zone outside the front of a coffee shop represented by block 21 in the map display 20, the user clicks on the map in the middle of the side of the block corresponding to the shop front (this point has real-world coordinates of x₁,y₁, in the present example); as a result, the zone specification template 24 appears with the zone position parameter already filled in as x₁,y₁. The author then gives values to the remaining zone specification parameters (Zone ID=‘Zone1’, Shape=‘semi-circle’, Size=‘r₁’, and Orientation=‘180°’) using, for example, dropdown boxes for selection of values where appropriate. Once all needed parameters have been given a value, the zone is displayed to scale on the map (see shaded area 22 in FIG. 2). With regard to the Orientation parameter, it is convenient to display a reference vector for the zone (dotted arrow 23 for Zone1 in FIG. 2), the reference direction (corresponding to 0°) for which is straight up the displayed map.

FIG. 2 also shows the zone specification template 26 for Zone2, this zone (shaded area 25 on the map 20) being circular in the form and centred at geographic coordinates x₂,y₂ (in this example, this corresponds to a real-world park). Because the zone is circular, the Orientation parameter is left empty.

Other ways of facilitating the specification of geographic zones are, of course, possible such as by dragging a desired shape from a palette of possible shapes and dropping the shape where desired on the map and then rotating and changing the size of the shape as needed.

According to prior art methodologies, once authoring of a mediascape (however effected) has been completed, with all action-trigger conditions fully specified, the mediascape is released for download to users devices—for example, by being placed on a website relevant to the target environment for which the mediascape has been written (in this case, download is over the public internet), or by being passed to download kiosks physically situated in the target environment (in this case, download can conveniently be via a short-range radio link, such as a BlueTooth™ link, from a kiosk to a user device).

In embodiments of the present invention, at least one parameter of a location-based action-trigger condition is left by the mediascape author for customisation by a third party subsequent to release of the mediascape by the author. Preferably, the author can opt to specify, for each customizable parameter, a default value and/or constraints on the value that a third party can be set; the default value is the value to be used absent the specification of a specific value by a third party. A constraint may be expressed in absolute terms, relative to a real-world feature, or relative to the specified default value.

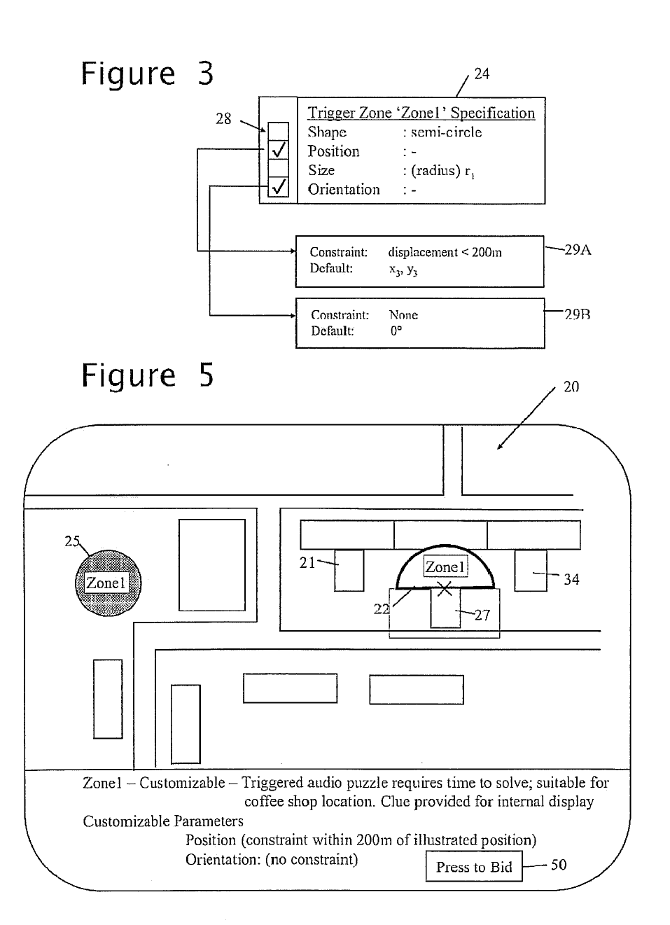

FIG. 3 illustrates the setting, during authoring of a mediascape script, of two parameters of the ‘Zone1’ trigger zone as customizable. As can be seen, in this example check boxes 28 are provided in the trigger zone specification template to enable the author to indicate parameters as customizable by checking the appropriate boxes—in this case the ‘Position’ and ‘Orientation’ parameters have been checked. Upon checking a parameter as customizable, the user is presented with an input box 29 for specifying constraints and a default value for the parameter concerned. Thus, in the present example, after checking the ‘Position’ parameter as customizable, the author is presented with box 29A where he enters a default position x₃, y₃ corresponding to the front of a building 27 (see FIG. 2), and a constraint that the customized position must be within 200 metres of the default position. Similarly, after checking the Orientation parameter, the author sets into box 29B a default orientation value of zero degrees with no constraints on its customization.

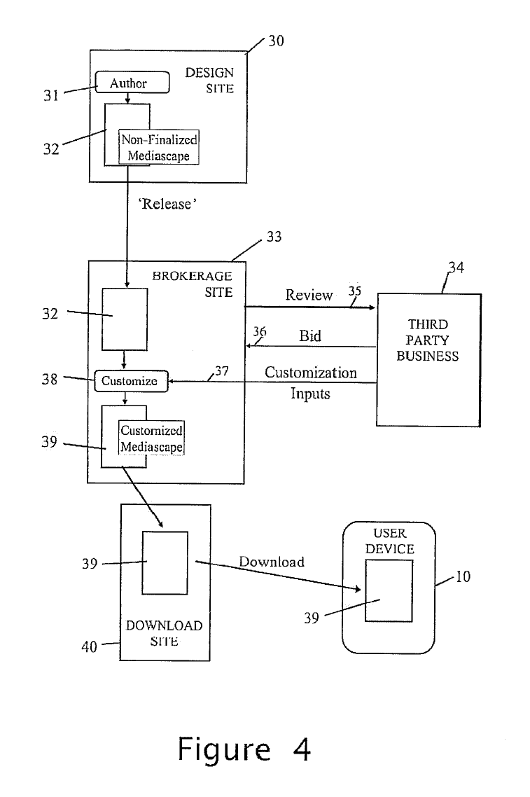

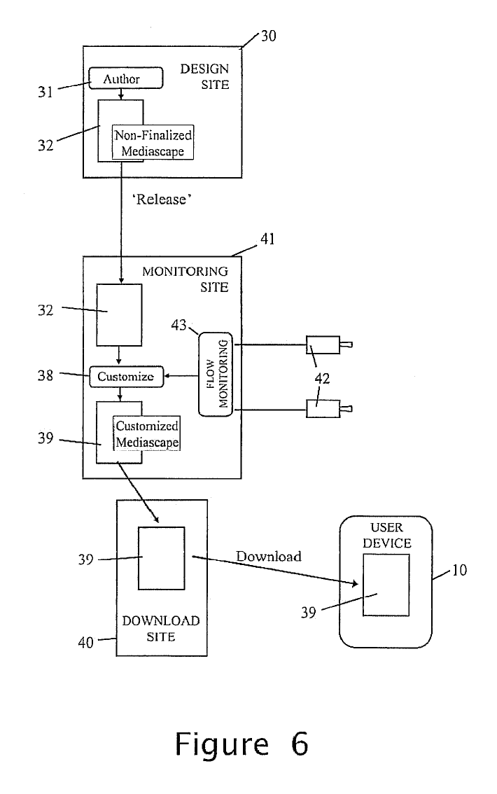

FIGS. 4 and 6 illustrate respective example scenarios of mediascape customization subsequent to release from design by the author. For convenience, it will be assumed that the mediascape concerned is that described above with the customizable trigger zone Zone1. Furthermore, the media item puzzle.mp3′ played upon the user device 10 sensing itself to be in Zone1 is taken to be the recital of a puzzle intended to take a little while to decipher, something conveniently done over a cup of coffee. As a result, there is likely to be commercial benefit to a coffee shop owner in having Zone1 located outside their establishment, particularly if the puzzle media item implies that a clue can be found in a coffee shop.

Considering first the FIG. 4 scenario, following the design (authoring) 31 at design site 30 of the mediascape 32 (including its non-finalized script with the Position and Orientation parameters of Zone1 left customizable), the mediascape is released for third-party customization by being passed to a brokerage site 33. At the brokerage site the mediascape is made available for review by third parties 34, in particular businesses within the mediascape target environment; this can conveniently be done using a website only accepting registration by bone fide business organisations. The mediascape is presented to interested third parties 34 so that they can review the mediascape (arrow 35) and understand what it is about and how users are intended to interact with it—in particular, the existence of customizable trigger zones is made evident together with an indication (if not obvious) what advantages are to be gained by having the trigger zone adjacent a particular business (such indications are preferable prepared at the same time as authoring of the mediascape). The third parties can then bid for the right to customize one or more customizable trigger zones.

FIG. 5 illustrates one way in which the customizable nature of a trigger zone can be indicated, this example being given for Zone1 of the above described mediascape. As can seen, the trigger zones Zone 1 and Zone2 are shown on map display 20 with the customizable Zone1 being displayed (at its default position) with a different fill to Zone2. By clicking on the customizable Zone1, a description is brought up in the lower part of the screen indicating the commercial advantages of having zone1 located near a particular business together with an indication of which parameters are customizable and any constraints on customization. A bid button 50 is also provided to enable an interested third party to make a bid (arrow 36 in FIG. 4) for the right to customize Zone1.

The party 34 making the winning bid in respect of zone Zone1 is then given the opportunity to set specific values for the customizable parameters of this zone (arrow 37 and operation 38 in FIG. 4) to produce a customized version 39. of the mediascape ready for distribution to users. In the present example, the winning bid is, for example, made by the operators of a coffee shop located in building 34 with the result that the Position is customized to be immediately in front of building 34 and the Orientation set to 180°; furthermore, the party 34 making the winning bid is also told the clue to be displayed inside the coffee shop.

Rather than customization being a once off event, it can be arranged that the customization of a trigger zone is only effective for a fixed period of time (such as a week or a month); in this case, separate bids must be made for the right to customize for each such period. The periods involved can be one-off periods (such as a particular date) or cyclically repeating periods (such as weekday evenings, weekend evenings etc.).

After customization, the mediascape 39 (script and media items) is transferred to one or more download sites 40 for download to user devices 10 for use in the target environment.

In the second customization scenario, illustrated in FIG. 6, after the non-finalized mediascape 32 is released from design it is passed to a monitoring site 41 of a third party that has responsibility for managing the flow/distribution of people (or at least of device users) in the target environment. The monitoring site 41 has associated means, here depicted as cameras 42, for providing information on the current flow or distribution of people in the target environment (as an alternative to using cameras 42, the user devices can regularly provide position updates to the monitoring site). By monitoring the provided information (box 43), it is possible to spot flow congestion or over-usage of a location of interest corresponding to a trigger zone of the mediascape; conversely, it is also possible to spot sparsely used areas or under-usage of a location of interest corresponding to a trigger zone of the mediascape. In response, the customizable trigger locations of the mediascape can be customized to bring about an adjustment in the flow/distribution of device users. This can be done either on a long term basis (that is, problems noted during one week of operation can be used to adjust the position of trigger zones for the subsequent week—in this case, the version of the mediascape available from the download sites 40 being changed weekly), or on a short term basis (that is, adjustments to the trigger zone locations are brought on line immediately for new users by the new customization of the mediascape being passed immediately to the download sites 40).

It will be appreciated that many variants are possible to the above described embodiments.

For example, updating of the location-based triggers can be dynamically effected with changes being immediately pushed to user devices in the target environment by the download sites 40; alternatively, user devices 10 can be arranged to periodically ask for any updated location triggers from the download sites 40.

Furthermore, the positions of trigger zones (whether fixed or the default of customizable zones) can be specified relative to the location of another trigger zone; similarly, positional constraints on the position parameter of a customizable zone can be set relative to the position of another trigger zone.

As already described, a particular parameter customization can be arranged to have restricted validity, such as for a week. It is also possible to arrange for different values of a particular customizable parameter value to be valid for different user devices/users, the appropriate parameter value being downloaded after the downloading device 10 has identified itself or its user to the download site. It is therefore possible to ‘sell’ customization rights of a trigger zone not only by time period but also by specific user/user device or by type of user/user device. More generally, the right to control customization of a customizable parameter is divided into multiple lots of that light each of which is put up for bidding by third parties, the third party making the winning bid for a particular lot then controlling customization of the customizable parameter in respect of that lot, and the customized mediascape being deployed by lot.

Rather than the media items of a mediascape being stored on a user device, if there is good wireless connectivity in the target environment the media items can be stored off the user devices for streaming to each user device as needed; a mediascape can therefore be distributed in form.

1. A method of creating and managing a mediascape comprising:
authoring a mediascape for a target environment, the mediascape comprising media items and related action-triggers each specifying a condition set of one or more conditions, and at least one media-item-specific action that is to be triggered upon satisfaction of the condition set; the condition set of at least one action-trigger comprising a location-based condition authored with a customizable parameter;
releasing the mediascape to a third party with an indication of said customizable parameter;
customizing said customizable parameter in accordance with input from said third party; and
deploying the customized mediascape to users for use in said environment.

2. A method according to claim 1, wherein authoring of said location-based condition with said customizable parameter involves authoring a default value for the customizable parameter, this default value being intended for use in the event that the parameter is not customized prior to deployment of the mediascape.

3. A method according to claim 1, wherein authoring of said location-based condition with said customizable parameter involves authoring at least one constraint on the customization of the customizable parameter.

4. A method according to claim 1, wherein the mediascape is released to a brokerage site accessible to third parties, the method further comprising accepting bids from the third parties for the right to control customization of the customizable parameter, and determining a said bid as a winning bid; customizing of the customizable parameter being effected in accordance with input from the third party making said winning bid.

5. A method according to claim 4, wherein the right to control customization of the customizable parameter is divided into multiple lots of that right each of which is put up for bidding by third parties, the third party making the winning bid for a particular lot controlling customization of the customizable parameter in respect of that lot, and the customized mediascape being deployed by lot.

6. A method according to claim 5, wherein each said lot corresponds to a particular time period.

7. A method according to claim 1, wherein the mediascape is released to a monitoring site, operated by a third party, for monitoring the flow and/or distribution of users in the target environment, customizing of the customizable parameter being effected in dependence on the monitored flow and/or distribution of users in the target environment whereby to modify future flow and/or distribution of users.

8. A method according to claim 1, wherein both the media items and action-triggers of the mediascape are deployed to user devices for storage and use.

9. A method according to claim 1, wherein the action-triggers of the mediascape are deployed to user devices for storage and use, and the media items of the mediascape script are initially deployed to a store separate from the user devices for streaming to user devices as required by the triggering of an action of a said action-trigger.

10. A method according to claim 1, wherein action-triggers already deployed to user devices are dynamically updated to reflect a subsequent customization of said customizable parameter.

11. A computer readable medium storing a program for authoring at least action-triggers of a mediascape that comprises media items and related action-triggers each specifying a condition set of one or more conditions, and at least one media-item-specific action that is to be triggered upon satisfaction of the condition set; the program when executed on a computer providing functionality for facilitating the authoring of a location-based condition with a customizable parameter by presenting an author with an opportunity to select a parameter of the location-based condition as customizable, and storing an indication that the parameter is customizable upon selection of the parameter by the author as customizable, the program causing this indication to be stored as part of the authored mediascape.

12. A computer readable medium according to claim 11, wherein said functionality for facilitating the authoring of a location-based condition with a customizable parameter is arranged to present the author with an opportunity to set a default value for the customizable parameter.

13. A computer readable medium according to claim 11, wherein said functionality for facilitating the authoring of a location-based condition with a customizable parameter is arranged to present the author with an opportunity to set a constraint on customization of the customizable parameter.
